(19) United States
(12) Patent Application Publication
(10) Pub. No.: US 2021/0348705 A1
(43) Pub. Date: Nov. 11, 2021

(54) HOSE RETENTION APPARATUS

(71) Applicants: Garrett N. FRINK, Weare, NH (US); Norman FRINK, Henniker, NH (US)

(72) Inventors: Garrett N. FRINK, Weare, NH (US); Norman FRINK, Henniker, NH (US)

(21) Appl. No.: 17/314,405

(22) Filed: May 7, 2021

Related U.S. Application Data
(60) Provisional application No. 63/021,390, filed on May 7, 2020.

(51) Int. Cl. F16L 33/06; F16L 33/025

(52) U.S. Cl. CPC F16L 33/06; F16L 33/025

(57) ABSTRACT

A hose retention apparatus that has a handle and holding structure which has an interior area for holding a hose. One end of a connecting member is fixed to the handle and the other end is fixed to the holding structure such that the handle and the holding structure are spaced from each other. A passage extends through the connecting member and opens to the interior area of the holding structure. A push rod is arranged within the passage and extends from the passage into the interior area of the holding structure such that an outer end of the push rod is located within the interior area. The push rod is able to slide so as to clamp the hose between the outer end of the push rod and a remote side of the hose holding structure.

### CROSS REFERENCE TO RELATED APPLICATIONS/PRIORITY

This application claims the benefit of U.S. Provisional Patent Application No. 63/021,390, filed on May 7, 2020, which is herein incorporated by reference in its entirety.

### FIELD OF THE INVENTION

The present invention relates to a hose retention apparatus for indirectly holding and retaining a hose.

### BACKGROUND OF THE INVENTION

There are many different types of hoses, conduits, lines, channels or ducts, that are used to convey fluids, liquids or matter suspended within a fluid from one location to another. Common types of hoses, conduits, lines, channels or ducts and can include for example: hoses that deliver cement from a delivery truck to a job site; hoses that convey heating oil from a delivery truck to an oil storage tank inlet at a residential property; and hoses that convey sewage from a septic system or portable toilet to a sewage removal vehicle. Often, the outer surfaces of such hoses come into contact with the fluid, liquid or suspended matter being conveyed through the hose. Although operators for such service providers often wear personal protective clothing such as gloves when handling these hoses, direct contact with the hose is generally undesirable. Such direct contact with hoses that have become exposed to the fluid, liquid or suspended matter can be considered as being dirty and unhealthy.

### SUMMARY OF THE INVENTION

Wherefore, it is an object of the present invention to overcome the above-mentioned shortcomings and drawbacks often associated with the handling of such hoses.

Another object of the present invention is to provide an apparatus which enables grasping, holding and carrying hoses without directly contacting the hose.

The present invention also relates to a hose retention apparatus having a handle and a hose holding structure that defines an interior area through which a hose can pass from one end of the holding structure to an opposite end of the holding structure. An elongate connecting member has axial first and second ends. The first end of the connecting member is fixed to the handle and the second end of the connecting member is fixed to the hose holding structure such that the handle and the hose holding structure are spaced from each other by the connecting member. A central passage extends from adjacent the first end of the connecting member and through the connecting member and the hose holding structure such that the central passage is open to the interior area of the hose holding structure. A push rod is slidably arranged within the central passage and extends from the central passage into the interior area of the hose holding structure such that an outer end of the push rod is located within the interior area. The push rod is slidable to releasably clamp the hose between the outer end of the push rod and a remote side of the hose holding structure.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a front plan view of a hose retention apparatus according to the invention with the hose in a released position;

FIG. 2 is a side plan view of the hose retention apparatus according to FIG. 1;

FIG. 3 is a cross-sectional front view of the hose retention apparatus along section line 3-3 of FIG. 2;

FIG. 4 is a cross-sectional side view of the hose retention apparatus according to the invention with the hose in a released position;

FIG. 5 is a cross-sectional side view of the hose retention apparatus according to the invention with the hose in a clamped position;

FIG. 6 is a bottom view of the hose retention apparatus according to FIG. 1;

FIG. 7 is a cross-sectional front view of the hose retention apparatus along section line 7-7 of FIG. 2;

FIG. 8 is a cross-sectional front view of the hose retention apparatus along section line 8-8 of FIG. 2;

FIG. 9 is front plan view of a portion of another embodiment of the hose retention apparatus according to the invention.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention.

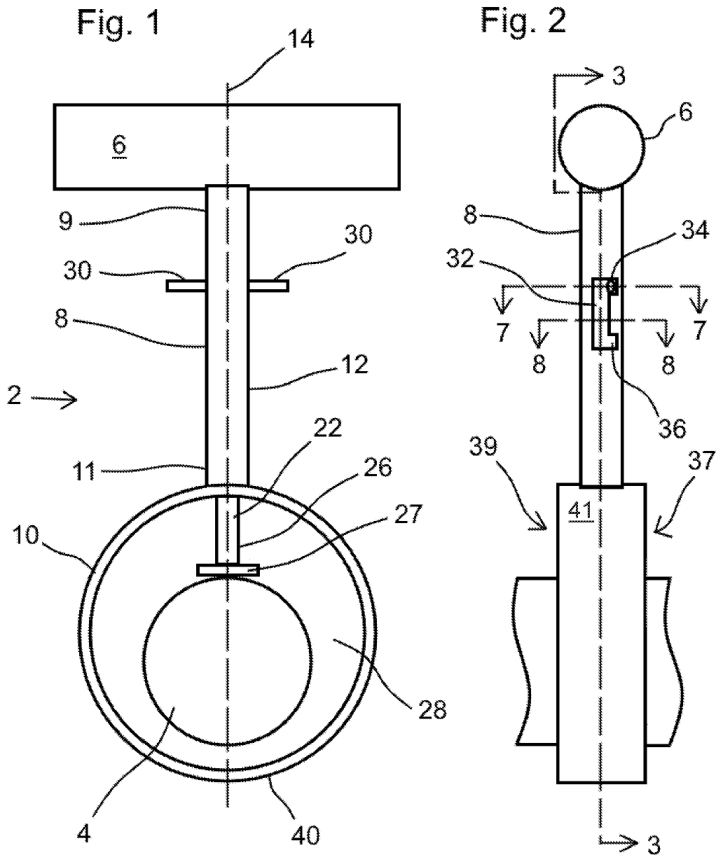

Turning now to FIGS. 1 and 2, a brief description concerning the various components of the present invention will now be briefly discussed. As can be seen in this embodiment, the present invention relates to a hose retention apparatus 2 which enables a hose, conduit, line, channel or duct 4 to be indirectly held and retained by an operator or service provider. For the sake of brevity, hereinafter the hose, conduit, line, channel or duct will be referred to simply as the hose 4. The hose retention apparatus 2 is configured such that the hose 4 can be held by the operator while maintaining the hose 4 at a distance from the hand and body of the operator. The hose retention apparatus 2 generally includes a handle 6 which can be grasped and held by the operator. An elongate, rigid connecting member 8 is connected at a first end 9 to the handle 6 and at the opposite second end 11 to a hose holding structure 10 such that the hose holding structure 10 is spaced at a fixed distance away from the handle 6. In use the hose holding structure 10 directly contacts and holds or retains the hose 4 in position relative to the hose retention apparatus 2. With the design of the hose retention apparatus 2, as described in further detail below, an operator can grasp the hose 4 without actually directly contacting it and can hold and maintain the hose 4 at a distance while lifting, carrying or otherwise manipulating the hose 4 for example.

The handle 6 enables the operator to grasp and hold the hose retention device 2 and is therefore designed to enhance the grip that the operator has on the hose retention device 2. The handle 6 is also configured to be comfortable while holding the hose retention device 2. The handle 6 is illustrated in FIG. 1 as being tubular or rather cylindrical and having a round or substantially round cross sectional contour. The handle 6 can be solid or hollow. Although not shown in FIG. 1, the handle 6 can be formed with a number of individual indentations along the side facing the rigid connecting member 8. These indentations can be slightly spaced apart from each other and formed to receive the fingers of the operator using the hose retention device thereby enhancing the fit and comfort of the handle 6 when grasped by a hand. It should be recognized that the handle 6 can have forms other than that of a round cylinder. For example the handle 6 can have the cross-sectional contour of an oval or polygon.

The handle 6 is formed from a material that is resilient and generally resistant to stress and loads place thereon. For example, the handle 6 can be formed from a metal pipe or rod, wood, or plastic. The handle 6 generally has a length that is long enough so as too comfortably fit the width of a hand. That is to say the handle 6 should have a length that allows all of the fingers of the operator to grasp the handle 6. Preferably, the axial length of the handle 6 is approximately 5.5 inches. The handle 6 has a diameter that is large enough to allow the operator to comfortably support the hose retention device in a hand. Preferably, the diameter of the handle 6 is approximately 1.0 inch. To further enhance the ability to grip and hold the handle 6, the outer surface of the handle 6 can be textured or have a covering. The outer surface of the handle 6 for example can be knurled to reduce slipping of the handle 6 within the hand. For the sake of comfort, the handle 6 can have a covering or coating of plastic, rubber, foam or the like.

As shown in FIG. 1, the first end 9 of the rigid connecting member 8 is connected to a central portion of the handle 6. The handle 6 and the connecting member 8 can be connected to each other in any manner however the connection should be integral and rigid such that all relative movement between the handle 6 and connecting member 8 is prevented. For example the handle 6 and the connecting member 8 can be welded together. It is also possible however for the first end 9 of the connecting member 8 to have an exterior thread which is screwed into a threaded bore in the central portion of the handle 6.

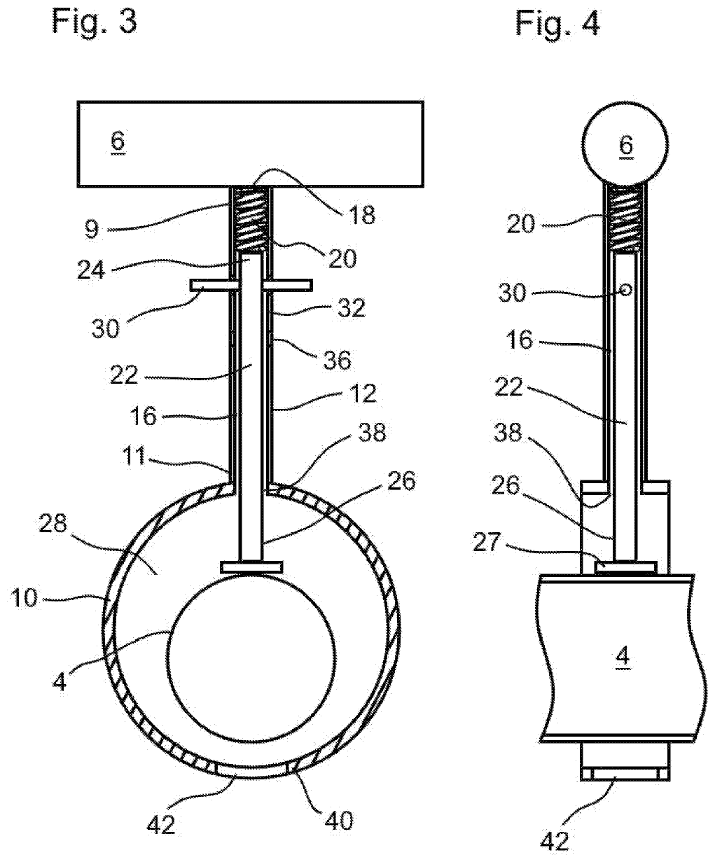

The connecting member 8 is formed from a material that is rigid and generally resistant to stress and loads place thereon. For example the connecting member can be formed by a length of generally hollow pipe such as a metal pipe or plastic tube. As shown at least in FIGS. 3 and 4, the connecting member 8 has a cylindrical wall 12 that defines a longitudinal axis 14 and forms a central passage 16 that extends from a stop 18 at the first end 9 to the opposite second end 11 of the connecting member 8. The stop 18 encloses the central passage 16 at the first end 9 while the central passage 16 is open at the second end 11 to the interior area 28 of the hose holding structure 10. The stop 18 can be formed by the outer surface of the handle 6 or can be formed by a plug that is fixed at the first end 9 of the connecting member 8.

The connecting member 8 generally has a length that sets the distance between the hand of the operator and the hose 4 being held by the hose holding structure 10. Preferably, the axial length of the connecting member 8 is approximately 5.75 inches. The diameter of the connecting member 8 should be sufficient enough such that a spring 20 and push rod 22 can be movably arranged within the central passage 16 as described below in further detail. Preferably, the diameter of the connecting member 8 is approximately 0.5 inches.

Arranged within the central passage 16 is a spring 20 and a slidable push rod 22. The spring 20 is located at the first end 9 of the connecting member 8 and the push rod 22 extends in an axial direction from the spring 20 through the open second end 11 of the connecting member 8. The push rod 22 has an inner end 24 that is in communication with the spring 20 and an outer end 26 that has a disk shaped engagement surface 27 which abuts the hose 4 thereby applying a holding force one the hose 4 as will be described in further detail below. The push rod 22 is sized to fit within the central passage 16 and extend from the central passage 16 into an interior area 28 of the hose holding structure 10. The diameter of the push rod 22 should be small enough to loosely fit within the central passage 16 and enable the push rod 22 to freely slide along the longitudinal axis 14. Preferably, the diameter of the push rod 22 is approximately 0.36 inches. As the hose retention apparatus 2 may be used for holding a variety of differently sized hoses, i.e., hoses of different diameters, the push rod 22 can be formed to have any axial length. The relative size or rather length of the push rod 22 will be described in further detail below.

The spring 20 and the push rod 22 function to lock or clamp the hose 4 against the hose holding structure 10 and thereby enable the operator to grasp and hold the hose 4 without physically touching it. One end of the spring 20 abuts the stop 18 and the other end of the spring 20 abuts an inner end 24 of the push rod 22. The spring 20 has a pre-load and functions to bias the push rod 22 in the axial direction out through the second end 11 of the connecting member 8. Movement of the push rod 22 in the axial direction is guided or rather controlled via one or more control pins 30 that extends laterally from the push rod 22 through corresponding slots 32, 34, 36 in the cylindrical wall 12. Although, FIGS. 1, 3 and 5 show the control pins 30 as extending from both sides of the push rod 22, it is to be appreciated that guidance or control of the push rod 22 can be accomplished by a single control pin 30 that extends from only one lateral side of the push rod 22 or a single control pin 30 that extends completely through the push rod 22 and through the slots 32, 34, 36 on opposite sides of the cylindrical wall 12. The control pin 30 can be secured to the push rod 22 in such a manner that the control pin 30 is releasably coupled to the push rod 22 such that the control pin 30 can be inserted into and removed from the push rod 22 as desired. For example, the control pin 30 can be friction fit with a through hole in the push rod 22 or the control pin 30 can have a threaded portion that engages with a threaded through hole in the push rod 22.

As shown in FIG. 2 of the hose retention apparatus 2, the cylindrical wall 12 has a number of slots including a longitudinal slot 32 and a pair of locking slots 34, 36 that extend laterally from corresponding ends of the longitudinal slot 32. As will be explained in more detail below, the push rod 22 moves along the central passage 16 with the control pins 30 extending through the slots 32, 34, 36 such that the push rod 22 can be moved between a retracted position with the control pin 30 located in the upper locking slot 34 and an extended position with the control pin 30 located in the lower locking slot 36.

The hose holding structure 10 has an upper side 41 with an aperture 38. The upper side 41 of the hose holding structure 10 is fixed to the second end 11 of the connecting member 8 such that the aperture 38 is aligned with the central passage 16 and the central passage 16 is open to the interior area 28 of the hose holding structure 10. The hose holding structure 10 is in the form of an annulus or ring having open faces 37, 39 and a remote (lower) side 40. The hose holding structure 10 is sized such that the hose 4 can be arranged within the interior area 28 of the hose holding structure 10 between the upper and lower sides 41, 40 thereof. The hose holding structure 10 at the same time should be big enough so as not to obstruct the fluid path within the hose 4. As the hose retention apparatus 2 may be used for a variety of differently sized hoses, i.e., hoses of different diameters, the hose holding structure 10 can be formed to have any diameter however it is to be understood that the diameter of the hose holding structure 10 generally relates to the diameter of the hose 4 as will be explained in further detail below. The width of the hose holding structure 10, i.e., the distance from one open face 37 to the other open face 39 (FIG. 2), also generally relates to the size and type of the hose 4 to be grasped and held with the hose retention apparatus 2. As the hose holding structure 10 forms a type of “base” against which the hose 4 will be pressed by the push rod 22, the width of the hose holding structure 10 should be large enough to support the hose 4 against the force of the push rod 22.

As an example, for holding and retaining a typical septic clean out hose having a diameter of approximately between 3 to 6 inches, the hose holding structure 10 preferably has a diameter of between 3.5 to 6.5 inches. The width of the hose holding structure 10 is preferably between 1.25 to 1.5 inches. It has been found that a hose holding structure 10 having a width of 1.25 inches provides a sufficient “base” to support a typical septic clean out hose 4, meaning a hose holding structure 10 of this size has a sufficient amount of surface area in contact with the hose 4 to retain the hose 4 in position while at the same time distributing the holding or retaining force placed on the hose 4 so as to avoid localized excessive pressure on the hose 4 which can lead to localized damage or compression of the hose 4 which can restrict or block fluid flow within the hose.

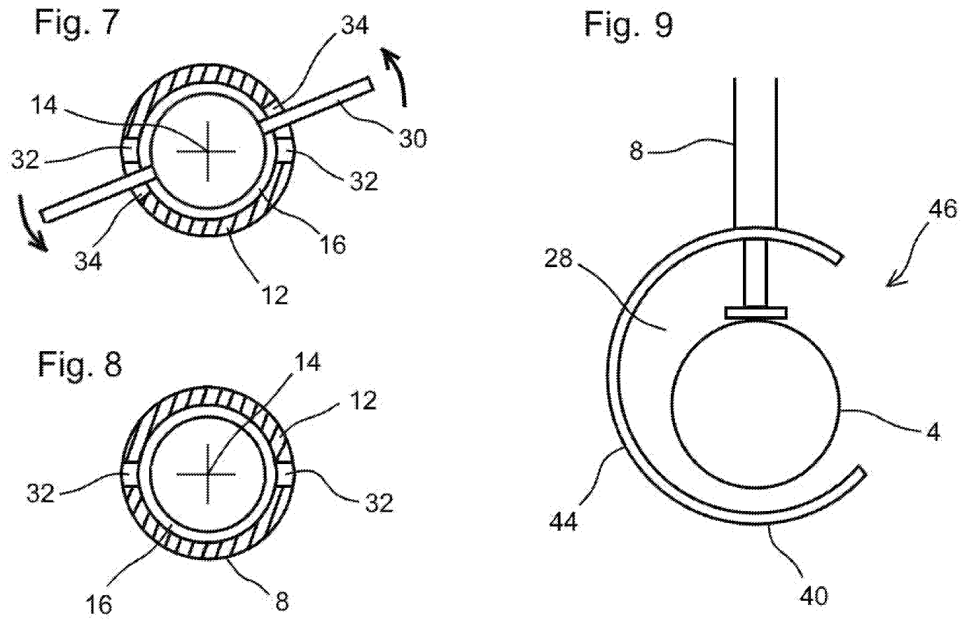

Operation of the hose retention apparatus 2 will now be described with reference to the figures. Initially, the push rod 22 is placed in its retracted position (see FIG. 3) by pulling the control pins 30 in the axial direction towards the handle 6 against the force of the spring 20. With this, the control pins 30 slide up along the longitudinal slot 32 until they abut the end of longitudinal slot 32 and are aligned with the upper locking slot 34. At this point the push rod 22 is rotated in a counter clockwise direction, as shown in FIG. 7 into the upper locking slot 34. With the control pins 30 located in the upper locking slot 34, the push rod 22 is oriented in the retracted position, that is to say the push rod 22 is pulled into the central passage 16 as far as possible. In this position, the outer end 26 of the push rod 22 is partially withdrawn out of the interior area 28 of the hose holding structure 10 such that the distance from the engagement surface 27 to the remote side 40 of the hose holding structure 10 is at a maximum. That is to say in other words that the “open” space or the space to receive the hose 4 in the interior area 28 is greatest.

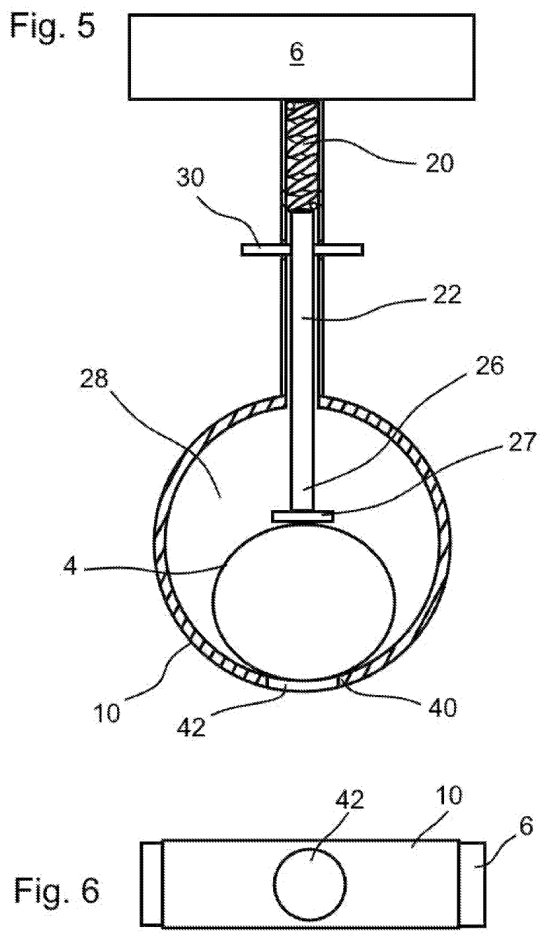

With the push rod 22 in the retracted position, the hose 4 is passed through the interior 28 of the hose holding structure 10 until the hose retention apparatus 2 is located at a desired position along the length of the hose 4. Once the hose retention apparatus 2 is positioned along the hose 4, the push rod 22 is rotated in a clockwise direction by the operator, via the control pins 30, such that the control pins 30 move from the upper locking slot 34 into the end of the longitudinal slot 32. At this point, the push rod 22 is biased or pushed toward the hose holding structure 10 by an axial force applied by the spring 20. At the same time, the control pins 30 move along the longitudinal slot 32, as shown in FIG. 8, in a direction toward the lower locking slot 36. During movement of the push rod 22 into the interior area 28 of the hose holding structure 10, the engagement surface 27 of the push rod 22 contacts the hose 4 and pushes the hose 4 into abutment with the remote side 40 of the hose holding structure 10, i.e., the side axially opposite the connecting member 8, as shown in FIG. 5. As the spring 20 biases the push rod 22 further in the axial direction, the engagement surface 27 applies a holding or clamping force on the hose 4, thereby clamping the hose 4 against the remote side 40 of the hose holding structure 10. When the push rod 22 is pushed down the central passage 16 until the control pins 30 abut the opposite end of longitudinal slot 32 and become aligned with the lower locking slot 36, the push rod 22 is rotated, via the control pins 30, in the counter clockwise direction by the operator and into the lower locking slot 36. With the control pins 30 located in the lower locking slot 36, the push rod 22 is locked in the extended position in which the distance from the engagement surface 27 to the remote side 40 of the hose holding structure 10 is at a minimum and the push rod 22 thereby maintains an axial “holding” force on the hose 4.

As shown in FIG. 5, in the extended position of the push rod 22, the axial force on the hose 4 may cause the hose 4 to slightly deform. With regard to the dimensions of the hose holding structure 10 as well as the axial length of the push rod 22 and the longitudinal slot 32, these are at least somewhat dependent on the size, i.e., diameter of the hose 4 to be held by the hose retention device 10. The important aspect of the sizes of these components is that they should be sized such that when the push rod 22 is in the retracted position, there is a sufficient amount of space for the hose 4 to be loosely passed through the interior area 28 of the hose holding structure 10. For example, as shown in FIG. 3 with the push rod 22 in the retracted position, only one of the engagement surface 27 and the remote side 40 of the hose holding structure 10 is in contact with the hose 4. The axial length of the push rod 22 and the longitudinal slot 32 should enable the engagement surface 27 of the push rod 22 to come into contact with the hose 4 as the push rod 22 is slid from the retracted position to the extended position and when in the extended position the engagement surface 27 should engage the hose 4 and apply enough force on the hose 4 to retain the hose 4 in position relative to the hose holding apparatus 10. In other words, as shown in FIG. 5 with the push rod 22 in the extended position, the engagement surface 27 and the remote side 40 of the hose holding structure 10 both contact the hose 4.

Given the preferred dimensions of the hose holding structure 10 and the connecting rod 8 as noted above, for holding and retaining a typical septic clean out hose, the push rod 22 preferably has a length of between 4.5 to 6.5 inches. The longitudinal slot 32 preferably has a length of between 0.75 to 1.25 inches.

As shown in FIG. 6 of the hose retention apparatus 2, the remote side 40 of the hose holding structure 10 has an aperture 42. The aperture 42 is aligned with the central passage 16 of the connecting member 8 and enables the push rod 22 and engagement surface 27 to pass through the remote side 40 of the hose holding structure 10. In this manner the push rod 22 can be removed from the central passage 16 for the purposes of cleaning or replacement. By removing the push rod 22 from the central passage 16 it is also possible to remove and replace the spring 20.

Turning now to FIG. 9, a second embodiment of the present invention will now be described. As this embodiment is very similar to the previously discussed embodiment, only the differences between this new embodiment and the previous embodiment will be discussed in detail while identical elements will be given identical reference numerals. In this embodiment, the hose holding structure 44 is C-shaped having a side 46 that is open to the interior area 28 of the hose holding structure 44. The open side 46 of the hose holding structure 44 allows the hose 4 to pass into the interior area 28 thereof where it can be clamped against the remote side 40 of the hose holding structure 44 as described above. As such the hose retention apparatus 2 can couple the hose 4 at any position along the length of the hose 4.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

Wherefore, I/We claim:

1. A hose retention apparatus comprising:
a handle and a hose holding structure having an upper side and an opposite remote side which define an interior area therebetween, and the hose holding structure being configured to receive a hose within the interior area;
an elongate connecting member having axial first and second ends, the first end of the connecting member being fixed to the handle and the second end of the connecting member being fixed to the upper side of the hose holding structure such that the handle and the hose holding structure are spaced from each other by the connecting member;
the connecting member defining a central passage that axially extends from adjacent the first end and through the second end of the connecting member and the upper side of the hose holding structure such that the central passage is open to the interior area of the hose holding structure; and
a push rod being arranged within the central passage and extending from the central passage into the interior area of the hose holding structure such that an outer end of the push rod is located within the interior area, the push rod being slidable to releasably clamp the hose between the outer end of the push rod and the remote side of the hose holding structure.

2. The hose retention apparatus according to claim 1, wherein the push rod being slidable between a retracted position and an extended position,
in the retracted position, the outer end of the push rod is at a first distance away from the remote side of the hose holding structure such that the hose is movable within the interior area relative to the hose holding structure, and
in the extended position, the outer end of the push rod is at a second distance away from the remote side of the hose holding structure that is less than the first distance such that the hose is clamped between the outer end of the push rod and the remote side and fixed relative to the hose holding structure.

3. The hose retention apparatus according to claim 1, wherein the push rod being slidable between a retracted position and an extended position, and
in the retracted position of the push rod, at most only one of the outer end of the push rod and the remote side of the hose holding structure contacts the hose, and in the extended position of the push rod, both of the outer end of the push rod and the remote side of the hose holding structure contact the hose.

4. The hose retention apparatus according to claim 1, wherein a spring applies a spring force on the push rod to bias the push rod from a retracted position into an extended position, and when the push rod is in the extended position, the outer end of the push rod is located closer to the remote side of the hose holding structure than when the push rod is in the retracted position.

5. The hose retention apparatus according to claim 4, wherein the spring is arranged within the central passage at the first end of the connecting member axially between the handle and an inner end of the push rod.

6. The hose retention apparatus according to claim 5, wherein the spring is configured to continuously apply the spring force on the push rod in an axial direction toward the interior area of the hose holding structure.

7. The hose retention apparatus according to claim 4, wherein the connecting member has an axially extending longitudinal slot, and the push rod has a control pin that extends laterally therefrom and through the longitudinal slot in the connecting member such that movement of the push rod within the central passage is limited by interaction of the control pin with the longitudinal slot.

8. The hose retention apparatus according to claim 7, wherein the control pin contacts one axial end of the longitudinal slot to stop movement of the push rod at the extended position and the control pin contacts an opposite end of the longitudinal slot to stop movement of the push rod at the retracted position.

9. The hose retention apparatus according to claim 8, wherein the connecting member has an upper locking slot that communicates with the opposite end of the longitudinal slot, the push rod and the control pin being rotatable to move the control pin from the longitudinal slot into the upper locking slot such that the push rod is lockable in the retracted position.

10. The hose retention apparatus according to claim 1, wherein a spring is arranged within the central passage and has one end that abuts a stop and an opposite end that abuts an inner end of the push rod, the spring applying a spring force on the push rod to bias the push rod in an axial direction toward the interior area of the hose holding structure, and
the connecting member having an axially extending longitudinal slot and the push rod having a control pin that extends laterally from the push rod and through the longitudinal slot such that axial movement of the push rod is limited to movement of the control pin within the longitudinal slot.

11. The hose retention apparatus according to claim 10, wherein the push rod being stopped in a retracted position when the control pin abuts the connecting member at one end of the longitudinal slot and the push rod being stopped in an extended position when the control pin abuts the connecting member at an opposite end of the longitudinal slot, and in the extended position the push rod the outer end thereof is located closer to the remote side of the hose holding structure than when the push rod is in the extracted position such that when the push rod is in the extended position the hose is clamped between the outer end of the push rod and the remote side of the hose holding structure.

12. The hose retention apparatus according to claim 11, wherein the outer end of the push rod control rod has an engagement surface that contacts the hose when the push rod is in the extended position.

13. The hose retention apparatus according to claim 2, wherein the hose holding structure is annular completely surrounds the interior area in which the hose is received.

14. The hose retention apparatus according to claim 2, wherein the hose holding structure is C-shaped having a open side that facilitates reception of the hose into the interior area of the hose holding structure.

15. The hose retention apparatus according to claim 12, wherein the remote side of the hose holding structure has an aperture that is aligned with the central passage of the connecting member and facilitates insertion of the push rod into the central passage and reception of the engagement surface into the interior area.

16. The hose retention apparatus according to claim 9, wherein the connecting member has a lower locking slot that communicates with the one axial end of the longitudinal slot, the push rod and the control pin being rotatable to move the control pin from the longitudinal slot into the lower locking slot such that the push rod is lockable in the extended position.
